(19) United States
(12) Patent Application Publication
(10) Pub. No.: US 2006/0053983 A1
(43) Pub. Date: Mar. 16, 2006

(54) Oil filter canister tool

(76) Inventor: Charles A. Groetsch, Vadnais Heights, MN (US)

Correspondence Address: BRIGGS AND MORGAN P.A., 2200 IDS CENTER, 80 SOUTH 8TH ST, MINNEAPOLIS, MN, 55402, US

(21) Appl. No.: 10/939,704

(22) Filed: Sep. 13, 2004

(51) Int. Cl. B25B 13/06

(52) U.S. Cl. 81/121.1

(57) ABSTRACT

A tool for removing an oil filter canister from an engine block. The oil filter canister is enclosed within the tool for removal. The tool also has a reservoir to catch any used oil draining out of the canister. The tool may include a lug for receiving a wrench to apply force to the tool to remove the canister. Another embodiment allows the tool to be used with a horizontally-mounted oil filter canister.

### BACKGROUND OF THE INVENTION

The present invention relates to a tool for removing an oil filter canister from an engine, and in particular to a tool which prevents dirty oil from soiling the operator's hands while at the same time avoiding crushing the oil filter canister.

There are many versions of oil filter tools currently available. In one such device (illustrated by U.S. Pat. No. 4,860,617) a strap is provided for encircling the filter cartridge, and a handle associated with the strap tightens the strap around the filter cartridge. The strap form of tool is relatively inexpensive and in theory is supposed to spread the gripping force about the complete periphery of the cartridge. All too often, however, the force necessary to turn the oil filter canister results in crushing of the typical thin sheet metal side walls of the filter cartridge. In most cases, the strap tool twists and crushes the canister before the canister turns, and the workman is then presented with a formidable task of removing the crushed, twisted canister from its mounting to the engine.

Other forms of tools have been devised to accommodate removal of an oil filter canister from its mounting to an internal combustion engine. Three similar type tools are described in U.S. Pat. Nos. 3,119,290; 3,910,140; and 4,532,835 wherein a socket-like tool is provided for accessing the oil filter cartridge axially. These tools bear a resemblance to a socket wrench that fits over the distal end of the oil filter cartridge. These tools have arcuate, encircling jaws that grasp the distal end of the oil filter cartridge, with torque being applied to the periphery of the distal end of the oil filter cartridge. Generally, in the socket form of tool described in the referenced patents, the socket portion is formed in two halves which may be drawn together by a cam and slot arrangement to engage and grip the periphery of the oil filter cartridge and provide removal torque. Unfortunately, the socket type of tool of the prior art has the same tendency as the strap tool mentioned previously to twist and crush the oil filter cartridge. Once the oil filter cartridge has been twisted and crushed, it is a very laborious, time consuming job to remove the twisted, crushed oil filter cartridge from its engagement to the engine. Another socket-type tool is illustrated in U.S. Pat. No. 5,461,948 and still another socket-type tool is shown in U.S. Pat. No. 4,643,053.

All of the previous tools share a common disadvantage in that the oil filter canister is not enclosed by the tool. Therefore, as soon as the canister is removed even slightly from the engine block, dirty oil runs down the outside of the canister and soils the operator's hands, and perhaps even burns them if the oil is hot enough. Some people are also allergic to engine oil. In addition, oil that runs down the outside of the canister may end up on the vehicle frame and thus contaminate the environment.

There is a need for an improved oil filter canister tool that solves the above problems.

### SUMMARY OF THE INVENTION

A tool for removing an oil filter canister from an engine, the tool comprising:

(a) a housing adapted to substantially enclose the oil filter canister therein;

(b) the housing having an open end, a closed end, and a side wall, the oil filter canister being adapted to be received in the open end; and

(c) a reservoir adapted to receive used oil from the oil filter canister.

A principle object and advantage of the present invention is that is prevents used oil from the engine from draining onto the operator's hands or the vehicle's frame. All oil from the canister goes into a reservoir in the tool.

Another principle object and advantage of the present invention is that it includes a used oil reservoir to hold small amounts of oil that drain out of the engine block.

Another principle object and advantage of the present invention is that it may include a lug for receiving a socket wrench to assist in turning the tool.

Another principle object and advantage of the present invention is an embodiment including an extension that mates with the tool to allow the tool to be used to remove horizontally oriented filter canisters. In this embodiment, an angled oil reservoir is included to drain used oil.

Another object and advantage of the present invention is that the housing substantially encloses the oil filter canister. This prevents the canister from being crushed (as in earlier tools) because rotational force is evenly applied to the canister, rather than being applied to a narrow region.

### BRIEF DESCRIPTION OF DRAWINGS

FIG. 1 is a perspective view of the tool of the present invention.

FIG. 2 is a top perspective view of the tool of the present invention.

FIG. 3 is a top plan view of the tool of the present invention.

FIG. 4 is an elevational view with some structure broken away.

FIG. 5 is a perspective view of another embodiment of the present invention.

FIG. 6 is a perspective view showing the use of the second embodiment.

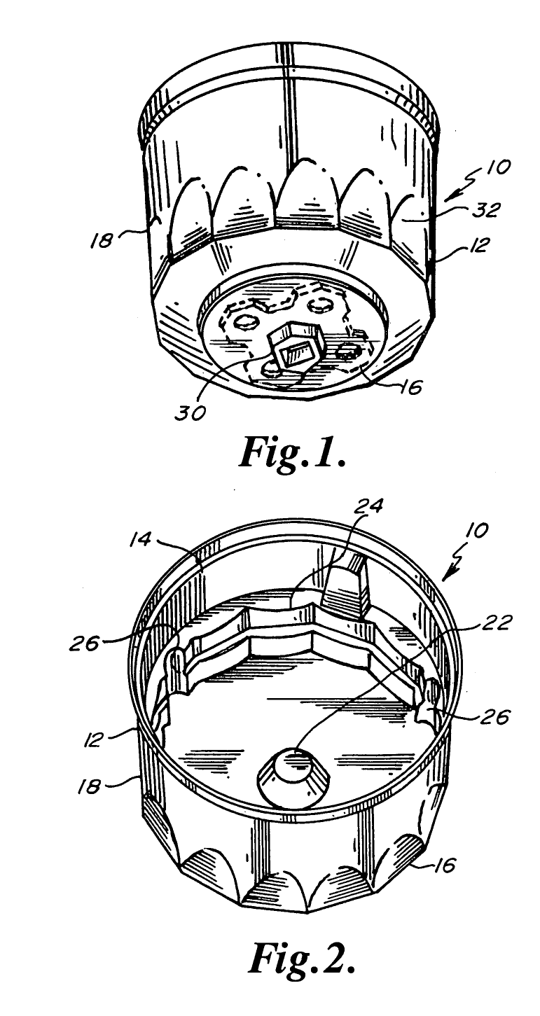

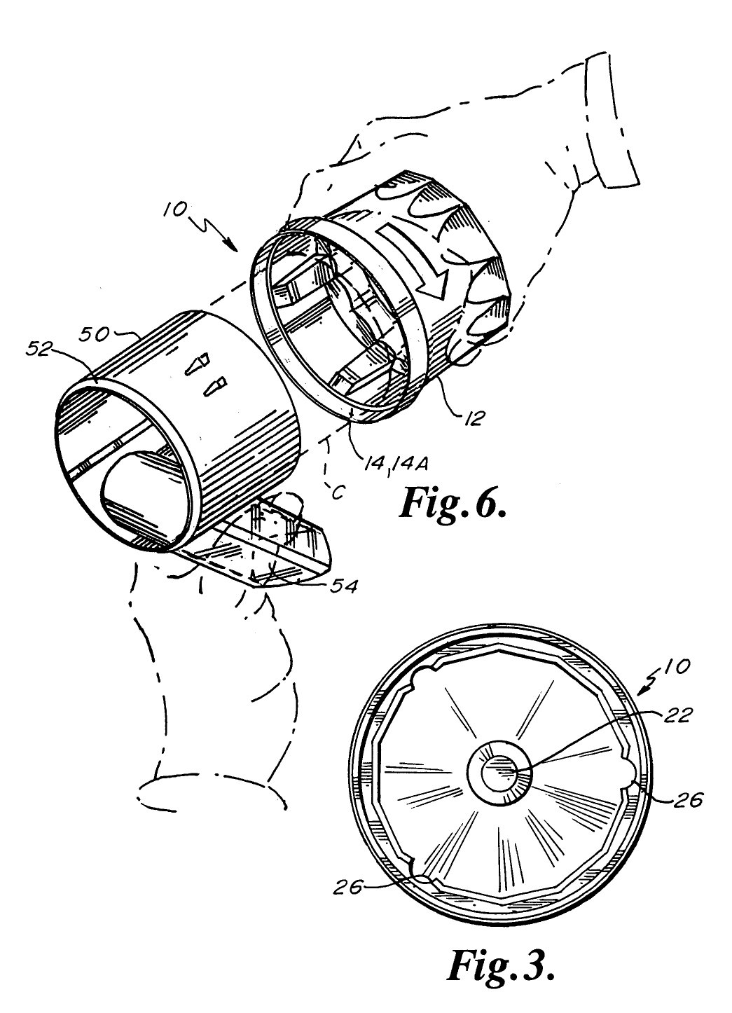

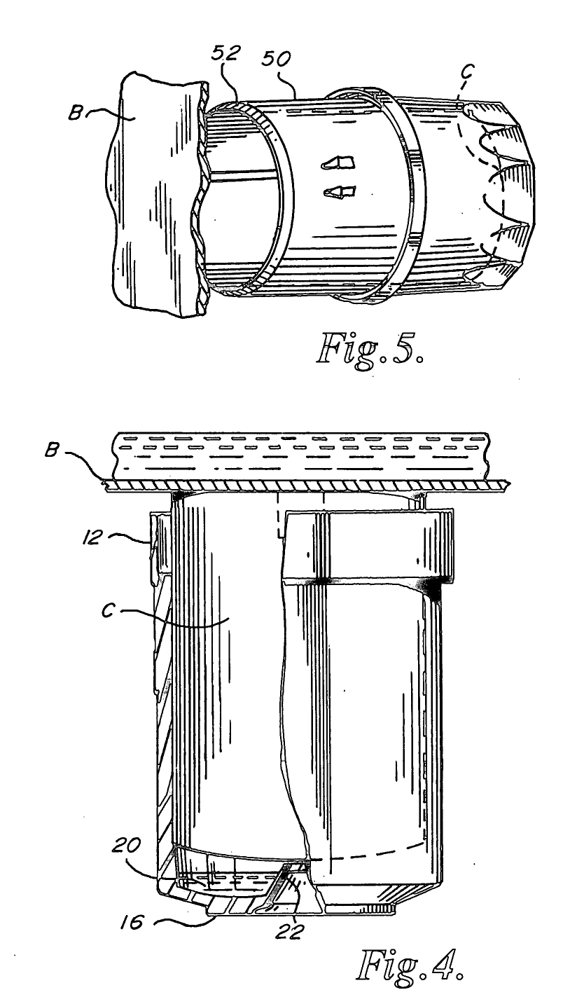

### DETAILED DESCRIPTION OF THE PREFERRED EMBODIMENT

The tool for removing an oil filter canister from an engine is generally shown in the Figures as reference numeral 10.

In one embodiment, the tool 10 comprises a housing 12 adapted to substantially enclose the oil filter canister C therein. The housing 12 has an open end 14, a closed end 16, and a side wall 18. The canister C is received in the open end 14. The tool 10 also comprises a reservoir 20 adapted to receive used oil from the oil filter canister.

Preferably, the closed end 16 has a raised portion 22 adapted to prevent the canister C from making substantial contact with the remainder of the closed end 16. In this manner, the reservoir 20 is formed between the canister C and the closed end 16. It should be understood, however, that the reservoir 20 may be provided by another portion of the housing.

Preferably, the side wall 18 has a plurality of raised portions 24 adapted to grip the canister C. The side wall 18 also has a plurality of channel portions 26 that allow oil from the oil filter canister C to drain toward the closed end 16. Most preferably, the channel portions 26 are between raised portions 24.

Preferably, the tool 10 further comprises a lug 30 protruding externally from the closed end 16, the lug 30 being adapted to receive a wrench for applying rotational force to the tool 10. Most preferably, the lug 30 is molded into the closed end 16. The lug 30 may comprise any material that can withstand the force of a wrench, such as steel or aluminum.

Preferably, the exterior of the housing 12 comprises a plurality of indentations 32 allowing the operator to grip the tool 10.

A second embodiment of the tool 10 is shown in FIGS. 5 and 6. The second embodiment includes a flared open end 14A and an extension 50 mating with the flared open end 14A. The extension 50 is adapted to receive the oil filter canister C substantially therein. The extension has a flanged end 52 adapted to contact the engine block B. Preferably, the flanged end 52 flexes to seal against the block B. As best seen in FIG. 6, the flared open end 14A rotates around the extension 50 as the operator grips the extension 50 with one hand and the tool 10 with the other hand. As the oil filter canister is unthreaded from the engine block, the flared end 14A begins to separate from the extension 50. However, the flared end is of sufficient depth that it never completely separates from the extension 50. In one embodiment, there is sufficient clearance between the canister C and the tool 10 that the operator may use the tool 10 in the manner of a socket wrench, alternatively gripping and releasing the canister in a ratcheting manner as the canister C is held tightly with the extension 50.

The second embodiment is particularly useful with oil filter canisters that are mounted substantially horizontally to the engine block. Preferably, the extension 50 has an angled oil reservoir 54 to receive used oil from the filter, so that no oil escapes from the tool.

Unless otherwise defined, all technical and scientific terms used herein have the same meaning as commonly understood by one of ordinary skill in the art to which this invention belongs. Although methods and materials similar to or equivalent to those described herein can be used in the practice or testing of the present invention, suitable methods and materials are described below. All publications, patent applications, patents, and other references mentioned herein are incorporated by reference in their entirety to the extent allowed by applicable law and regulations. In case of conflict, the present specification, including definitions, will control.

The present invention may be embodied in other specific forms without departing from the spirit or essential attributes thereof, and it is therefore desired that the present embodiment be considered in all respects as illustrative and not restrictive, reference being made to the appended claims rather than to the foregoing description to indicate the scope of the invention.

1. A tool for removing an oil filter canister from an engine having an engine block, the tool comprising:
(a) a rigid, one-piece housing adapted to substantially enclose the oil filter canister therein;
(b) the housing having an open end, a closed end, and a side wall, the oil filter canister being adapted to be received in the open end; and
(c) a reservoir adapted to receive used oil from the oil filter canister.

2. The tool of claim 1, the closed end having a raised portion adapted to prevent the oil filter canister from making substantial contact with the remainder of the closed end, thereby forming the oil reservoir between the canister and the closed end.

3. The tool of claim 2, the side wall having a plurality of raised portions adapted to grip the oil filter canister, and having a plurality of channel portions between the raised portions, the channel portions allowing oil from the oil filter canister to drain toward the closed end.

4. The tool of claim 1, further comprising a lug protruding externally from the closed end, the lug being adapted to receive a wrench for applying rotational force to the tool.

5. The tool of claim 4, wherein the lug is molded into the closed end.

6. The tool of claim 1, wherein the exterior of the housing further comprises a plurality of indentations allowing the operator to grip the tool.

7. The tool of claim 1, wherein the open end is flared and further comprising an extension mating with the flared open end, the extension adapted to receive the oil filter canister substantially therein, the extension having a flanged end adapted to contact the engine block, the flared open end rotating around the extension as the operator grips the extension with one hand and the tool with the other hand.

8. The tool of claim 7, wherein the flared open end and the extension begin to move apart along the oil filter canister as the oil filter canister is removed from the engine block.

9. The tool of claim 7, wherein the tool alternately grips and releases the oil filter canister, thereby acting like a ratchet.

10. The tool of claim 7, wherein the extension further comprises an angled oil reservoir.

11. A tool for removing an oil filter canister from an engine, the tool comprising:
(a) a rigid, one-piece housing adapted to substantially enclose the oil filter canister therein;
(b) the housing having an open end, a closed end, and a side wall, the oil filter canister being adapted to be received in the open end; and
(c) a reservoir adapted to receive used oil from the oil filter canister, wherein the reservoir is in the closed end.

12. The tool of claim 11, the closed end having a raised portion adapted to prevent the oil filter canister from making substantial contact with the remainder of the closed end, thereby forming the oil reservoir between the canister and the closed end.

13. A tool for removing an oil filter canister from an engine having an engine block, the tool comprising:
(a) a housing adapted to substantially enclose the oil filter canister therein;
(b) the housing having an open end, a closed end, and a side wall, the oil filter canister being adapted to be received in the open end;
(c) wherein the open end is flared and further comprising an extension mating with the flared open end, the extension adapted to receive the oil filter canister substantially therein, the extension having a flanged end adapted to contact the engine block, the flared open end rotating around the extension as the operator grips the extension with one hand and the tool with the other hand; and
(d) a reservoir adapted to receive used oil from the oil filter canister.

14. The tool of claim 13, wherein the reservoir further comprises an angled oil reservoir in the extension.
